(19) United States
(12) Patent Application Publication
(10) Pub. No.: US 2005/0158225 A1
(43) Pub. Date: Jul. 21, 2005

(54) Structure level of silica from silica slurry method

(76) Inventors: Patrick D. McGill, Darlington, MD (US); Bridget E. Wildt, Bel Air, MD (US)

Correspondence Address: Carlos Nieves, Esq.;J. M. Huber Corporation, 333 Thornall Street, Edison, NJ, 08837-2220, US

(21) Appl. No.: 10/760,753

(22) Filed: Jan. 20, 2004

(51) Int. Cl. C01B 33/12

(52) U.S. Cl. 423/335

(57) ABSTRACT

A method of dewatering a slurry comprising water and precipitated silica is provided. The method allows for the separation of water-insoluble abrasives from slurry to obtain material for quality control testing that is on a laboratory scale and is capable of being performed in a reasonable amount of time.

### BACKGROUND OF THE INVENTION

Most dentifrice compositions (such as toothpastes) include an abrasive substance in order to remove various types of deposits that adhere to teeth. These deposits (particularly pellicle film deposits) impart an unsightly yellowing or stained appearance to teeth. Preferably, this abrasive substance provides excellent cleaning benefits, without being so abrasive so as to harm teeth. Thus, an effective dentifrice abrasive material maximizes the amount of pellicle film removal and minimizes damage to the hard tooth tissue material.

While many different materials have been used as abrasives in dentifrices, formulators have come to recognize precipitated silicas, which are useful in a broad range of manufactured products ranging from cosmetic and food products to industrial coatings and elastomeric materials, as perhaps the best dental abrasive material. In dentifrice products precipitated silicas offer several advantages. First, they provide excellent cleaning benefits without being excessively harsh; moreover the degree of cleaning provided can be specifically controlled by changing the structure level of the silica material. Second, precipitated silicas are extremely versatile, capable of functioning not only as abrasives, but also as fillers and thickeners. Third, when compared with other commonly used dentifrice abrasives (notably alumina and calcium carbonate) silicas have a relatively high compatibility with important active ingredients such as fluoride. Because of this functional versatility, and also because silicas have a relatively high compatibility with active ingredients like fluoride compared to other dentifrice abrasives (notably alumina and calcium carbonate), there is a strong desire among toothpaste and dentifrice formulators to include them in their products.

Conventionally, silica material has been supplied to the dental industry in free-flowing, dry powder form. Because the precipitated silica is manufactured in aqueous process, it is necessary to separate the silica precipitate from the aqueous fraction of the reaction mixture by filtering, washing, and drying procedures. Moreover, for precipitated silicas to be used in dentifrices, it is additionally necessary to mechanically comminute the material in order to provide the silica material in a suitable particle size and size distribution.

These additional drying and comminuting steps are particularly undesirable because they require considerable expenditures for equipment and operating costs, and increase the time necessary for manufacture. Accordingly, it has become desirable to supply these water-insoluble abrasives as rheologically stable liquid abrasive slurry compositions containing appropriately sized abrasive particles that can be prepared as part of a continuous process flow and without the need for costly drying and dry milling/comminuting post-treatments. Such abrasive slurries are disclosed in U.S. Pat. Nos. 6,403,059, 6,419,174, and 6,652,611.

While supplying abrasives in slurry form has the aforementioned advantages, it has also created the need for a method to separate the silica abrasive from the slurry for quality control testing purposes. Structural determination of the abrasive is one such quality control test. Other quality control tests that may be performed on the separated silica abrasive include measurement brightness, surface area and the like.

Structural determination of the abrasive is a particularly important matter. Silica can be broadly classified as high structure, medium structure and low structure. Generally, higher structure silica is particularly effective at thickening a dentifrice, while lower structure silica is more abrasive and thus particularly effective at providing cleaning and polishing benefits. Since this is a continuous scale it is useful to set product specifications around the structure value of the silica as determined by oil absorption.

Given the foregoing there is a need for a straightforward method for the separation of water-insoluble abrasives from slurry to obtain material for quality control testing that is on a laboratory scale and is capable of being performed in a reasonable amount of time.

### BRIEF SUMMARY OF THE INVENTION

The invention includes a method of dewatering a slurry comprising water and precipitated silica comprising the steps of: (a) providing a slurry comprising water and precipitated silica; (b) adding deionized water to the slurry; (c) mixing the slurry; (d) removing the silica from the slurry by means of a centrifuge; (e) drying the silica; (f) milling the silica into a silica powder; and (g) measuring the structure level of the silica powder.

The invention also includes a method of dewatering a slurry comprising water and precipitated silica comprising the steps of: (a) providing a slurry comprising about 10 wt % to about 60 wt % precipitated silica, about 3 wt % to about 80 wt % humectant, and about 5 wt % to about 50 wt % water; (b) adding deionized water to the slurry in a ratio of deionized water to precipitated silica of about 2:1 to about 20:1; (c) mixing the slurry; (d) removing the silica from the slurry by means of a centrifuge, wherein the centrifuge is operated at a speed of at least 4000 rpm; (e) drying the silica in a microwave oven; (f) milling the silica into a silica powder; and (g) measuring the structure level of the silica powder by use of the oil absorption rub out method.

### DETAILED DESCRIPTION OF THE INVENTION

All parts, percentages and ratios used herein are expressed by weight unless otherwise specified. All documents cited herein are incorporated by reference. The following describes preferred embodiments of the present invention, which provides a method for the separation of water-insoluble abrasive from slurry and the determination of the abrasive structure recovered from the slurry.

While silicas will be illustrated herein as the abrasive polishing agent component provided in the abrasive compositions being separated and tested by this invention, it will be understood that the principles of the present invention are also considered applicable to suspensions or slurries of other water-insoluble abrasives and silica thickeners. Other such water-insoluble particles include, for example, precipitated calcium carbonate (PCC), dicalcium phosphate dihydrate, silica gel and calcium pyrophosphate. The separation process may also be used for testing water-insoluble abrasives in slurries for other quality control parameters beyond structure determination such as brightness or surface area.

By “mixture” it is meant any combination of two or more substances, in the form of, for example without intending to be limiting, a heterogeneous mixture, a suspension, a solution, a sol, a gel, a dispersion, or an emulsion.

By “slurry” it is meant a free-flowing, pumpable suspension of fine solid material in a liquid.

By “centrifuge” it is meant a rotating device or technique for separating suspended particles of a solid material in a liquid suspension by centrifugal force.

By “oil absorption” it is meant the volume of oil required per unit weight of sample to completely saturate the sample's sorptive capacity. Oil absorption is an indicator of the structure of a test material.

The instant invention relates to a quick, laboratory scale method for separating silica from a silica-water-humectant slurry for silica structure level determination. In particular the invention relates to a procedure for effecting such separation by a novel centrifuge technique wherein a slurry comprising silica, water, and humectant is centrifuged to remove the silica from the slurry. The resultant silica is “washed” and dried before the structure is measured by determining the silica oil absorption.

The method of silica separation from silica slurry and structure level determination of the present invention are accomplished according to the following process.

In the first step of the process, an aqueous abrasive slurry is provided. For example, the aqueous abrasive slurry may have been manufactured by the methods described in U.S. Pat. Nos. 6,403,059, 6,419,174 and 6,652,611.

Most typically the aqueous abrasive slurry comprises undried water insoluble abrasive particles in combination with a liquid medium comprising humectant, whereby the abrasive particles are suspended in the slurry is provided. The silica slurry to be processed according to this invention is obtained from a supply of manufactured material for which quality control testing is needed and generally contains from about 10 to about 60 weight percent of abrasive particles, from about 3 to about 80 weight percent of humectant, and from about 5 to about 50 weight percent water. Suitable humectants include glycerin (glycerol), sorbitol, polyalkylene glycols such as polyethylene glycol and polypropylene glycol, hydrogenated starch hydrolyzates, xylitol, lactitol, hydrogenated corn syrup, and other edible polyhydric alcohols, used singly or as mixtures thereof, with sorbitol and glycerin particularly preferred. Prior to processing, the abrasive slurry is preferably mixed to ensure sample consistency.

In the next steps of the method the aqueous slurry is “washed”, with the humectant being removed from the slurry to enable silica structure determination. In these washing steps deionized water is added to the slurry and the slurry is then centrifuged and the supernatant decanted.

The washing of the silica slurry begins by adding deionized water to the slurry. The ratio of silica slurry to deionized water should be maximized as much as practical to allow for sufficient dissolving and removal of humectant. Humectant remaining in the pores of the silica can block oil from being absorbed and therefore can result in artificially low oil absorption values. The ratio of silica slurry to deionized water should be greater than about 1:2 preferably about 1:2 to about 1:20, more preferably about 1:3 to about 1:10. After addition of the deionized water, the sample should be mixed, for example on a No. 30 Red Devil Paint Conditioner for approximately 3-5 minutes, to ensure sample consistency.

Next, the aqueous slurry is centrifuged at a speed of preferably at least 4000 rpm, such as a speed range of from about 4000 rpm to about 8000 rpm. Centrifuging at higher speeds is preferable because it reduces the amount of silica fines lost thus yielding more accurate oil absorption values. The slurry should be centrifuged for at least 5 minutes, preferably in the time range of about 5 minutes to about 30 minutes. The result is an agglomerated silica portion separated from a supernatant that contains water and also possibly a humectant as described above. The supernatant is then decanted.

Preferably these washing steps are repeated at least 2 times, more preferably 3 times to 4 times to optimize the removal of the humectant.

After the completion of the aforementioned washing steps, the agglomerated silica material remaining after the last decanting is then subjected to drying. This drying can be effected by any conventional laboratory equipment used for drying silica, e.g., oven, microwave. Care must be taken that the drying operation and subsequent operations do not detrimentally affect the structure of the silica. Microwave drying is the preferred method. The microwave drying time is determined by repeated weighing until the silica shows less than about 0.04 g weight loss, such as about 12 minutes. Microwave drying was chosen over oven drying in order to speed the process. Statistical analysis of the oil absorption of silica dried in the microwave versus an oven indicated that microwave drying does not statistically differ from oven drying.

After the drying of the silica material, the silica is then subjected to grinding. Preferably the dried silica is ground to a +325 mesh (>45 μm) residue level of less than about 2.0% for subsequent quality control testing. Any conventional laboratory scale grinding and milling equipment can be used, e.g. a coffee grinder.

Next, the silica structure level is determined using an oil absorption rub out method. This rub out method is described in greater detail in the examples that follow. Preferably linseed oil is used, although other oils used frequently to determine silica structure, such as DOP or DBP, may be substituted.

Additionally, while structure determination of silica abrasives is specifically illustrated, it will be appreciated that the invention contemplates structure determination of silica thickeners and other oral care abrasives as well. Moreover, the process disclosed herein can be also used to evaluate materials as ingredients in a variety of end use product applications, such as cosmetic and food products, industrial coatings and elastomeric materials.

The invention will now be described in more detail with respect to the following, specific, non-limiting examples.

### EXAMPLE 1

In this example, silicas with different structures (oil absorption values) were generated in order to validate the inventive method of determining oil absorption of silicas in slurry form. Validation of this method requires that the structure of the silica be known before and after the silica is incorporated into slurry.

Four silicas were generated in a pilot-plant setting under the same conditions, with the exception of reaction temperature and the temperature of the excess silicate initially charged into the reactor. These temperatures were varied to obtain slightly different structured silicas. The temperatures used for silicas 1-4 are given in Table 1 below.

The silica precipitation reaction began with addition of 34 liters of sodium silicate (13.0%, 3.3 mole ratio) charged into a 1000 liter reactor equipped with an agitator. The agitator was set to 50 rpm and the silicate preheated to the desired temperature. Next, simultaneous addition of sulfuric acid (11.4%) and sodium silicate (13.0%, 3.3 mole ratio) began at rates of 3.8 lpm and 12.8 lpm, respectively. The silicate addition was stopped after 47 minutes while the acid addition was continued until the reactor slurry reached a pH of 6.0. Recirculation of the reactor contents at a flow rate of 37.9 liters per minute began after the silicate addition was stopped. After the reactor slurry reached a pH of 6.0, the pH was further adjusted to 5.5-5.8 by manual addition of the acid. The precipitation process was completed by digesting the slurry for 10 minutes at a temperature of 89.4° C.

The silica was recovered by filtration on an EIMCO plate and frame filter. The silica wet cake was then adjusted to approximately 23% solids with water and bead-milled using a Premier Mill, model #HML 1.5 available from Premier Mill Company, Reading, Pa. The milled slurries containing water and silica were then filtered, oven dried and milled further to reduce the +325 mesh residue to less than 2%. This second milling was accomplished using a 6-inch, hand operated, screw-fed, Raymond Laboratory Mill available from Alstom Power, Inc., Lisle, Ill. The silicas were milled with the laboratory mill until the +325 mesh residue was less than 2%, which more closely represented silica made on a commercial scale. The median particle size (MPS) was determined on each of the powders after bead milling and after milling with the laboratory-sized mill.

TABLE 1
Silica Process Parameters

| | Silicate | Reaction |
|---|---|---|
| Example | temperature | Temperature |
| 1 | 65 | 70 |
| 2 | 73.4 | 78.4 |
| 3 | 71 | 76 |
| 4 | 83 | 88 |

In order to further expand the structure range of the silicas used for the inventive process, two commercially available silicas from J.M. Huber Corporation, Zeodent® 105 and Zeodent® 114, were used. Silica 5 is Zeodent 105 silica and Silica 6 is a blend of 50% Zeodent 105 and 50% Zeodent 114 silicas. Wet cakes of these products were milled and tested in the same manner as the Silicas 1-4. Physical properties of Silicas 1-6 are summarized in Table 2 below.

TABLE 2
Physical Properties

| | MPS | Oil Absorption |
|---|---|---|
| | μm | ml/100 g |
| Silica 1 | 6.7 | 86 |
| Silica 2 | 8.5 | 81 |
| Silica 3 | 5.0 | 97 |
| Silica 4 | 10.4 | 68 |
| Silica 5 | 7.6 | 61 |
| Silica 6 | 8.4 | 74 |

Median Particle size (MPS) was determined using a Model LA-910 laser light scattering instrument available from Horiba Instruments, Boothwyn, Pa. A laser beam is projected through a transparent cell which contains a stream of moving particles suspended in a liquid. Light rays which strike the particles are scattered through angles which are inversely proportional to their sizes. The photodetector array measures the quantity of light at several predetermined angles. Electrical signals proportional to the measured light flux values are then processed by a microcomputer system to form a multi-channel histogram of the particle size distribution.

Oil absorption, using linseed oil, was determined by the ASTM D-281 rubout method. This method is based on a principle of mixing oil with silica by rubbing with a spatula on a smooth surface until a stiff putty-like paste is formed. By measuring the quantity of oil required to have a paste mixture which will curl when spread out, one can calculate the oil absorption value of the silica−the value which represents the volume of oil required per unit weight of silica to saturate the silica sorptive capacity. Calculation of the oil absorption value was done as follows:

$$\begin{matrix}Oil absorption = \frac{ml oil absorbed}{weight of silica , grams} \times 100 \\ = ml oil \text{/} 100 gram silica\end{matrix}$$

### EXAMPLE 2

After the initial dry silica oil absorption results were obtained, the dried silica powders were then incorporated into a slurry containing silica, water, sorbitol and a preservative. The pH of each of these slurries was adjusted to approximately 7.4. The exact weight of each of these components in the slurry is given in Table 3 below.

TABLE 3
Slurry Formulation

| | Silica used | Silica | Water | Sorbitol | |
|---|---|---|---|---|---|
| Slurry | in Slurry (g) | (g) | (g) | (g) | Preservative |
| 1 | Silica 1 | 691.68 | 473.99 | 471.25 | 1.19 |
| 2 | Silica 2 | 543.33 | 398.82 | 375.06 | 0.94 |
| 3 | Silica 3 | 914.69 | 654.35 | 624.74 | 1.57 |
| 4 | Silica 4 | 593.71 | 447.945 | 414.86 | 1.04 |
| 5 | Silica 5 | 571.56 | 429.17 | 398.46 | 1.00 |
| 6 | Silica 6 | 629.64 | 475.998 | 440.22 | 1.11 |

The silica/water/sorbitol slurry was mixed to ensure sample consistency. Then 100 g of the slurry and 200 g of deionized water was weighed into a 500-ml canister (9.5 cm high×9.5 cm diameter) and capped. The slurry and water were shaken for 1 minute on a paint can shaker. Thereafter, the slurry was centrifuged for 15 minutes at 6000 rpm in a Beckman Allegra 6 Centrifuge, Model #ALS98J21 available from Beckman Coulter, Inc., Fullerton, Calif. The supernatant was decanted and deionized water was again added to the settled silica to bring the total weight in the canister back to 300 g. The canister was capped and shaken on the paint shaker for another minute, then centrifuged a second time for 15 minutes at 6000 rpm. The resulting supernatant was decanted and the process was repeated twice more for a total of 4 centrifuge/washes. After decanting the supernatant from the final centrifuge run, the remaining slurry was placed in a crucible and dried at 105° C. overnight in a Lab-Line Imperial III Radiant Heat Oven, Melrose Park, Ill. Finally, the sample was milled in a Procter Silex coffee grinder for about 30 seconds to gently break up the slightly agglomerated silica. The oil absorption was then determined by the manner described above and are summarized in Table 4 below.

TABLE 4

| | Silica Oil Absorption | Silica Oil Absorption |
|---|---|---|
| | Initial | After Slurry Separation |
| Silica | ml/100 g | ml/100 g |
| 1 | 86 | 86 |
| 2 | 81 | 82 |
| 3 | 97 | 97 |
| 4 | 68 | 65.5 |
| 5 | 61 | 65 |
| 6 | 74 | 76.5 |

The regression analysis of the oil absorption before and after incorporation into the slurry was performed by Minitab® Statistical Software. The analysis resulted in a p-value of 0.00 and an R² value of 97.1% which indicated that the variables correlate at a significance level greater than 0.005.

### EXAMPLE 3

To further optimize the procedure, experiments were run to evaluate the effectiveness of washing on the recovered silica oil absorption value. It was theorized that increasing the number of washings reduced the amount of sorbitol available to the silica pores which would thereby provide more accurate oil absorption values. To evaluate the number of washing steps necessary to obtain an accurate oil absorption value, a silica/water/sorbitol slurry was made as described for slurry 1 above in Example 2. The slurry was washed by adding water to the slurry in a canister and mixing on a paint can shaker followed by centrifugation and decanting for the number of times indicated in Table 5. Washing effectiveness was determined by measuring the residual % carbon after each washing step on a portion of the silica separated from the slurry and dried. The only significant carbon in the slurry comes from the sorbitol.

TABLE 5

| No. Washings | % C |
|---|---|
| 0 | 2.74 |
| 1 | 0.27 |
| 2 | 0.05 |
| 3 | 0.02 |
| 4 | 0.03 |

Residual carbon was determined using a combustion type carbon analyzer, such as a model LECO SC-144DR, available from LECO Corporation, St. Joseph, Mich. The sample was heated to 1350° C. in a stream of oxygen and the carbon is oxidized to form CO₂. An IR cell measures the concentration of CO₂ and converts this value to a % C from a calibration curve using the sample weight.

It is seen in the above table that 2 to 3 washings are satisfactory to remove sorbitol (% C) from the silica.

### EXAMPLE 4

In this example, the effect of water to silica ratio in the washing step was evaluated. It was theorized that increasing the ratio of water to silica during centrifugation would increase the amount of sorbitol removed and thereby improve the accuracy of the oil absorption determination. Slurry 1 was made as described above in Example 2 by mixing silica 1, sorbitol and water in the percentages given. 50 g of this slurry was added to a canister along with a specified quantity of water. The mixture was centrifuged for 5 minutes at 4000 rpm then the supernatant was decanted. The silica was filtered and dried. Carbon was determined on the dried silica utilizing 1 g of silica in a LECO carbon analyzer.

It was found that with a ratio of 1 part slurry to 2 parts added water, the silica contained 4.96% carbon and had an oil absorption value of 74 ml/100 g. With a ratio of 1 part silica to 5 parts water added, the silica contained 2.40% carbon and had an oil absorption value of 79 ml/100 g. Therefore, it is shown that increasing the ratio of water to slurry improved sorbitol removal during centrifugation/decanting.

### EXAMPLE 5

The effect of centrifuge speed was evaluated on the inventive method. Silica 3 was used to make silica/water/sorbitol Slurry 3 as described above in Example 2. As before, 50 g of the slurry was added to a canister with 250 ml water, mixed and then centrifuged at either 4000 rpm or 8000 rpm, supernatant decanted then centrifugation and decanting repeated for a total of 2 washings. The slurry was filtered and the retained silica dried overnight at 105° C., lightly milled and then the oil absorption and % carbon of the recovered dried silica was determined and is summarized in Table 6 below.

TABLE 6

| | Oil absorption | Oil absorption | |
|---|---|---|---|
| | Starting material | After 2 washings | |
| RPM | ml/100 g | ml/100 g | % C |
| 4000 | 97 | 95 | 0.12 |
| 8000 | 97 | 97 | 0.16 |

It is seen in the table above that the centrifuge speeds tested had minimal effect on the determined silica oil absorption after separation form the slurry.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of dewatering a slurry comprising water and precipitated silica comprising the steps of:
(a) providing a slurry comprising water and precipitated silica;
(b) adding deionized water to the slurry;
(c) mixing the slurry;
(d) removing the silica from the slurry by means of a centrifuge;
(e) drying the silica;
(f) milling the silica into a silica powder; and
(g) measuring the structure level of the silica powder.

2. The method of claim 1, wherein steps (b)-(d) are repeated one or more times.

3. The method of claim 1, wherein the silica slurry comprises about 10 wt % to about 60 wt % precipitated silica, about 3 wt % to about 80 wt % humectant, and about 5 wt % to about 50 wt % water.

4. The method of claim 1, wherein the deionized water is added in a ratio of deionized water to precipitated silica of about 2:1 to about 20:1.

5. The method of claim 1, wherein the deionized water is added in a ratio of deionized water to precipitated silica of about 3:1 to about 10:1.

6. The method of claim 1, wherein the centrifuge is operated at a speed of at least 4000 rpm.

7. The method of claim 1, wherein the centrifuge is operated at a speed of at least 8000 rpm.

8. The method of claim 1, wherein in step (e) drying is done with a microwave oven.

9. The method of claim 1, wherein in step (f) the silica powder is milled to a +325 mesh residue level of less than about 2%.

10. The method of claim 1, wherein the structure level in step (g) is measured by use of the oil absorption rub out method.

11. A method of dewatering a slurry comprising water and precipitated silica comprising the steps of:
(a) providing a slurry comprising about 10 wt % to about 60 wt % precipitated silica, about 3 wt % to about 80 wt % humectant, and about 5 wt % to about 50 wt % water;
(b) adding deionized water to the slurry in a ratio of deionized water to precipitated silica of about 2:1 to about 20:1;
(c) mixing the slurry;
(d) removing the silica from the slurry by means of a centrifuge, wherein the centrifuge is operated at a speed of at least 4000 rpm;
(e) drying the silica in a microwave oven;
(f) milling the silica into a silica powder; and
(g) measuring the structure level of the silica powder by use of the oil absorption rub out method.
